(19) United States
(12) Patent Application Publication
(10) Pub. No.: US 2010/0016531 A1
(43) Pub. Date: Jan. 21, 2010

(54) PROCESS OF FLUOROMONOMER POLYMERIZATION

(76) Inventors: Libin Du, Cleveland, OH (US); Joseph M. DeSimone, Chapel Hill, NC (US)

Correspondence Address: MYERS BIGEL SIBLEY & SAJOVEC, PO BOX 37428, RALEIGH, NC, 27627, US

(21) Appl. No.: 12/376,986

(22) PCT Filed: Aug. 8, 2007
(86) PCT No.: PCT/US07/17683

§ 371 Date: Feb. 27, 2009

Related U.S. Application Data
(60) Provisional application No. 60/837,012, filed on Aug. 11, 2006.

(51) Int. Cl. C08F 14/18; C08F 2/06; C08F 18/20; C08F 16/24; C08F 12/20

(52) U.S. Cl. 526/208; 526/89; 526/209; 526/213; 526/245; 526/247; 526/251

(57) ABSTRACT

Methods of making fluoropolymers from at least one fluoromonomerin either (1) a heterogeneous medium comprising a carbon dioxide and an aqueous phase with or without hydrocarbon surfactants or dispersants or stabilizer, or (2) a homogenous medium containing carbon dioxide with one or more organic solvents, are described.

### RELATED APPLICATIONS

This application claims the benefit of U.S. Provisional Patent Application Ser. No. 60/837,012, filed Aug. 11, 2006, the disclosure of which is incorporated by reference herein in its entirety.

### FIELD OF THE INVENTION

The present invention is in the field of polymerization of fluoromonomers. More specifically, it concerns processes, reagents, compositions, conditions and methods for making fluoropolymers in environmentally friendly polymerization media without using bio-accumulating fluorinated surfactants.

### BACKGROUND OF THE INVENTION

The conventional processes of fluoromonomer polymerization include aqueous polymerization, which is further categorized into dispersion and suspension polymerization, and solution polymerization in some chlorofluorocarbon or perfluorocarbon solvents such as 1,1,2-trichlorotrifluoroethane (FC-113) which once was a major solvent used therein. The later process has always been used by only a small portion in the industry and some of the chlorinated solvents used therein have been affected by the Montreal Protocol due to their ozone layer depleting and green house effect. The alternative media have long been sought since then. A number of more environmental friendly solvents, such as hydrofluorocarbons and hydrofluoroethers, have been used or reported as possible replacements. However, their viability is limited due to their commercial availability, cost efficiency and environmental concerns.

Conventional suspension polymerization does not require the presence of surfactants in the process and the polymers may be directly filtered without the need for some other processes such as coagulation and washing, as required in dispersion polymerization. Since the free-radical initiator used in suspension polymerization is usually compatible with organic solvents or so-called oil-soluble, the concentration of ionic end groups is substantially reduced compared to that of polymers from dispersion polymerization. The disadvantages include the difficulty of uniformly incorporating multiple monomers in copolymerization as well as the relatively large and irregular size plus broad size distribution of the so-obtained polymer particles.

The conventional dispersion, or emulsion, polymerization of fluoromonomers uses long chain fluorinated surfactants, especially perfluorooctanoic acid (PFOA) and its salts (mostly ammonium salt which is also called C-8), as dispersants and has been the primary process in making a wide variety of commercial fluoropolymers. The process is well known in the art; see for example U.S. Pat. Nos. 2,559,752 to Berry, 3,271,341 to Garrison; 4,380,618 to Kahn et al; 4,864,006 to Giannetti et al; 5,789,508 to Baker et al, etc. A variety of fluorosurfactants that can be used in the process have also been disclosed in these patents. Fluorinated surfactants, mostly perfluorinated and sometimes containing one or two CH₂ units, are usually used exclusively in the process due to their non-telogenic property (that is, no or low chain transfer in the presence of propagating fluoropolymer radicals and does not produce low molecular weight in the polymer products). In the process, one or more fluoromonomers are usually polymerized in the aqueous medium in the presence of a water-soluble radical initiator as well as a certain amount of perfluorinated surfactants along with other co-reagents, such as paraffin wax as colloid stabilizer and some non-telogelic organic acid as buffer. The resulting fluoropolymer is in the form of latex and has to be degassed, coagulated, filtered and washed before being dried into polymer powder or be concentrated into the commercial latex through a upconcentration process which include several different techniques. See, for example, an evaporation process as taught in U.S. Pat. No. 3,316,201 to Hahn et al, a decantation process as in U.S. Pat. No. 3,037,953 to Marks et al. or an ultrafiltration process in U.S. Pat. No. 4,369,266 to Kuhls et al.

During these processes, part of the fluorosurfactants might have been removed. Very often, a treatment using either fluorine gas or other means has to be performed in order to reduce the adverse effect of the excessive ionic end groups associated with the ionic initiators used in the process. Another disadvantage associated with the ionic end groups is the high Mooney viscosity, which tends to cause great difficulty in processing the so-obtained polymers. Moreover, the surfactants as well as the coagulants, buffers, deformers, plasticizers and other possible co-reagents required by the processes tend to leave impurities in the final products or materials which certainly is not desired for some applications requiring high purity of the polymers such as in semiconductor industry.

Beyond the above mentioned disadvantages, a current issue in conventional dispersion polymerization of fluoromonomers is the use of long chain perfluorinated surfactants such as ammonium perfluorooctanoate (C-8) which have been determined to be persistent pollutants and be able to bioaccumulate in humans. Related industries have phased out or are in the process of phasing out these chemicals. Reduction in the use of these fluorosurfactants is desired in other industries as well.

This environmental issue has been partly solved by the recovery or recycling of fluorosurfactants which may be performed as taught in U.S. Pat. No. 3,882,153 to Seki et al or U.S. Pat. No. 4,282,162 to Kuhls to the aqueous phase after coagulation of polymers. A further separation employs ion exchange resin to absorb the fluorosurfactants. In order not to coagulate the dispersion in the exchange process, usually a relatively large amount of non-ionic or anionic non-fluorinated surfactants was added in advance, or sometimes during or after the processes, into the dispersion, then the dispersion gets contact with some anion exchanger to remove the fluorosurfactant from the dispersion. The suitable non-ionic non-fluorinated surfactants could be selected from a wide variety of commercially available hydrocarbon surfactants among which some are claimed to be more environmentally beneficial over the others. The anionic exchanger could be either a fixed resin bed or non-fixed resin. See, for examples, the processes disclosed in PCT publication No. WO. 2000/35971 to Blaedel et al; U.S. Pat. Nos. 20030220442 A1 and 20040143052 A1 to Epsch et al; PCT publication No. WO. 2003/051988 A2 to Bladel et al; U.S. Pat. No. 6,861,466 B2 to Dadalas et al; U.S. Pat. No. 20050189299 A1 and 20060148973 A1 to Malvasi et al.

There are a number of general disadvantages associated with the above processes. For example, PCT publication No. 2000/35971 to Blaedel et al discloses a fixed bed anion exchange process which can effectively reduce the fluorosurfactant level to 5 ppm or less. However, such a process is usually not economically viable in an industrial scale where usually a huge volume of polymer dispersion is waiting to be treated. The process typically does not work well to a concentrated polymer dispersion or latex where the solids percentage can be up to 75% and the viscosity is exceptionally high. Additionally, a dedicated anion exchange bed is usually needed for every single grade of fluoropolymer, otherwise an extensive recovering and washing cycle of the bed to avoid contamination will ensue. Moreover, a breakthrough of th column is very likely to happen in the long term if the gelation of the anionic exchange bed can not be avoided. Still further, this process is vulnerable for large particles which could exist in some polymer dispersion and a severe coagulation will result thereafter. Finally, it is also prone to form some abraded anion exchange resin particle during the exchange process which is detrimental to the purity of the treated polymers. In another embodiment in the same application, an aqueous dispersion is stirred with free anion exchange resin to reduce the fluorosurfactant level to below 5 ppm. However, it is still undesirable as an industrial process in consideration of its low loading of the anion exchange resin and a relatively long treatment process.

A recent process of further removing fluorosurfactant form aqueous fluoropolymer dispersions, as disclosed in PCT Publication No. WO 2006/020721 A1 to Noelke et al, uses a fabric pouch containing fluorosurfactant absorbent in manufacturing, storage and transportation. The process has advantages such as avoiding the increase of dispersion production cycle time, allowing the use of larger scale production equipment as well as more absorbents. However, the level of fluorosurfactant (less than 50 ppm) is still relatively high and can not be completely removed in this process so that a potential leaking to environment still exists. A desirable solution to the problem appears to be a polymerization process which does not require any involvement of fluorosurfactant therein and also in any other post-treatment steps.

PCT publication Nos. WO 1996/24622 to Oxenrider et al and WO 1997/17381 to McCarthy et al disclose a dispersion polymerization process of fluoromonomers without the aid of fluorinated surfactant. The process generally deals with the homopolymerization and copolymerization of chlorotrifluoroethylene, so apparently the applicability of the process to other fluoromonomer polymerization should be very limited. The resulting polymer is said to be self-emulsified and the dispersions can hold up to 50% solids with a wider range of particle size as in conventional dispersion polymerization. The initiation of the process uses a redox radical initiator system which is usually added once or multiple times during the polymerization. This process has some disadvantages such as higher requirements on facility and control, and higher risk of technical problems associated with the dual feed of reducing and oxidizing agents. Moreover, the molecular weight and the molecular weight distribution appear not to be in the best consideration while their importance in real applications certainly can not be neglected.

PCT publication No. WO. 2002/088207 A1 to Kaspar et al. disclose another process of fluoromonomer polymerization in the absence of fluorosurfactant. The process is easier to operate without sacrificing the yield and polymerization rate compared with the prior art, and the resulting polymer dispersion is also claimed to have good latex stability despite the fact that the particle size was somewhat larger than those obtained in the conventional process. However, the process is only applicable to some copolymers, especially those with vinylidene fluoride being the major component or comonomer, so the scope of this process may also be very narrow.

U.S. Pat. No. 5,824,755 to Hayashi et al. and U.S. Pat. No. 6,277,937 B1 to Duvalsaint et al. disclose a suspension process of polymerizing vinylidene and other fluoromonomers including tetrafluoroethylene to make fluoroelastomers. The process employs a non-fluorinated dispersant and an oil-soluble organic peroxide initiator dissolved in a hydrocarbon solvent. The dispersants include, for example, methyl cellulose, carboxymethyl cellulose, bentonite, talc, and diatomaceous earth. The hydrocarbon solvents include, for example, some regular alcohols, formates, acetates and ketones with hydrogen, methyl and tert-butyl group on the R position of the general formulas of R₁OH, R₂COOR₁ and R₁COR₃. The hydrocarbon dispersants and solvents are claimed to be non-telogelic when being used in small quantity and do not cause severe or appreciable effect on molecular weight and properties of the polymers. However, the polymerization process is in the category of suspension polymerization; the particle size and the stability of the resulting polymer suspension are not comparable to those of polymer latex obtained from dispersion polymerization.

There are some new processes of fluoromonomer polymerization and the media used therein which do not require the presence of fluorosurfactants. The methods do not have the environmental problem posed by the fluorosurfactants. For example, U.S. Pat. No. 5,496,901 to DeSimone discloses a process of polymerizing a variety of fluoromonomers in solvent comprising a carbon dioxide fluid, preferably supercritical carbon dioxide, to make fluoropolymers. The preferred fluoromonomers therein are fluoroacrylate monomers. U.S. Pat. No. 5,981,673 to DeSimone et al provides a process for polymerizing fluoromonomers in a non-aqueous medium comprising liquid or supercritical carbon dioxide for making fluoropolymers with stable end groups. U.S. Pat. No. 5,824,726 to DeSimone et al discloses a polymerization process in a multi-phase medium comprising carbon dioxide and an aqueous phase, with or without a surfactant, for making a water insoluble polymer. The suitable monomers contain regular hydrocarbon monomers as well as a variety of fluorinated monomers such as many fluoroolefins used in making commercial fluoropolymers in industry. Some of these processes have been integrated into industrial production process. See, for example, the process disclosed in U.S. Pat. No. 6,051,682 to Debrabander et al. These processes are good alternatives to the conventional solution as well as suspension polymerization process.

However, the improvement on conventional aqueous polymerization, especially dispersion polymerization which heavily rely on fluorosurfactants, has been limited. The current status in this field is that the aqueous dispersion polymerizations of most fluoromonomers are still being carried out in the presence of fluorosurfactants followed by one or more special processes designed to remove the fluorosurfactants. By this method, the fully removal of fluorosurfactant is very time and energy consuming which is undesirable in industrial production. A compromise by leaving trace amount of fluorosurfactant in the polymers does not meet future environmental goals. The current dispersion polymerization process without using fluorosurfactants is only limited to some fluoropolymers made from a small group of fluoromonomers. An alternative process which can produce the similar grades of fluoropolymers without using the fluorosurfactants as in conventional dispersion polymerization and can be compatible to most of fluoromonomers, old technologies, facilities and applications to a maximum extent would be desirable.

### SUMMARY OF THE INVENTION

The present invention is concerned with two separate processes of making fluoropolymers from at least one fluoromonomer in either (1) a heterogeneous medium comprising a carbon dioxide and an aqueous phase with or without hydrocarbon surfactants or dispersants or stabilizer, or (2) a homogenous medium containing carbon dioxide with one or more organic solvents either compatible or expandable with carbon dioxide in the presence or absence of stabilizers.

The carbon dioxide phase in heterogeneous medium may be in gas, liquid, supercritical and sub- or near-critical state. The polymerization may be a suspension polymerization with or without dispersant under high agitation or a dispersion polymerization using one or more hydrocarbon dispersants with or without other stabilizing agents in the presence of free-radical initiator. Other additives such as paraffin wax and buffers may be applied. The particle morphology, bulk density and solid contain of slurry or latex can be adjusted by some factors including, but not limited to, ratio of aqueous to carbon dioxide phase, concentration and type of dispersants and other reagents, reaction pressure, temperature, agitation rate and solid contents.

The homogeneous medium comprises a mixture of carbon dioxide and organic solvent or solvent mixture compatible with or expandable by carbon dioxide. Carbon dioxide may be either in gas or liquid or supercritical or sub-critical state. The organic solvents that are useful in this art have substantially less chain transfer than most other regular hydrocarbon organic solvents or are termed as non-telogenic in presence of fluoroalkyl radicals. The polymerization may proceed as solution, precipitation, suspension or dispersion polymerization, which may be inherent or tunable by ratio of the solvents and other possible factors. In solution or precipitation polymerization, one or more organic solvents may be used. In suspension polymerization, stabilizing agents may or may not be used. In dispersion polymerization, one or more dispersants or surfactants are used and the type and concentration are dependent on the specific solvent or solvent ratio and other applicable factors. Chain transfer agents may or may not be used in the processes. Other necessary additives may also be added.

Another aspect of this invention is regarding the polymer or polymer grade generated in the above processes or mediums. The polymer may contain characteristic end groups associated with the specific hydrocarbon dispersants in the heterogeneous medium or the specific expanded organic solvents in the homogeneous medium. The process may also provide polymer grades which are unique compared with those obtained in conventional processes or mediums.

### DETAILED DESCRIPTION OF EMBODIMENTS OF THE INVENTION

The advantages of using the media and processes in this invention compared with the current systems may be numerous. In the heterogeneous medium comprising an aqueous and a carbon dioxide phase of this invention, by adding carbon dioxide into the conventional aqueous polymerization medium, the surface tension between plasticized fluoropolymer and water phase may be reduced, so that a hydrocarbon surfactant may be used wherein a fluorinated surfactant is required otherwise. The primary advantage using this medium will be the successful replacement of currently embattled long chain fluorinated surfactants such as C-8 with non-fluorinated surfactants or inorganic dispersants which are certainly more environmental friendly and less costly. The resulting polymer latex and polymer grades may be still compatible with the current technology and facility or only need minor modifications, a revolution embraced by the related industry in consideration of the usually high initial investment on hardware associated with almost any new technology. Moreover, new grades of fluoropolymers may be created using the new polymerization system to satisfy more areas of applications such as in medical and food industry where toxicity of materials is the top concern.

For the homogeneous medium containing carbon dioxide and expanded solvent or solvent mixture, the apparent advantages, again, may be environmental and cost benefits. Some technical advantages can also be achieved or envisioned, especially on control and rational design of polymer structure. By using different carbon dioxide expended solvent media, the solubility of monomers and polymers in the solvents may be tunable. The rational tuning may be performed in order to improve the solubility of some monomers, especially monomers with relatively large molecule sizes or high molecular weights such as some macromonomers used for making polymer brush, in copolymerization of multiple monomers to improve diffusion of monomers throughout polymerization so that the copolymers will have evenly or randomly distributed repeating units and more homogeneous and predictable structures. It may also be targeted to improve or reduce the solubility of the resulting polymer in polymerization, such as tuning the solubility to switch from solution polymerization with the resulting polymer being dissolved in polymerization medium into precipitation polymerization so that solid polymer rather than polymer solution may be obtained. It could also be a switch from solution polymerization into suspension or dispersion polymer or vice versa. By tuning the solvent strength during the polymerization, the propagating copolymers, such as core-shell polymer, may adopt different morphology in different stages of polymerization so that the resulting polymers with more diversified structures may be produced.

Further, an improvement may be obtained for those monomers, catalysts or other co-reagents that are not compatible with carbon dioxide. Using carbon dioxide expanded solvent system may improve the solubility of certain monomers or co-reagents by changing solvent or adjusting solvent ratio so that the scope of polymerization that can be carried out in carbon dioxide may be largely expanded.

Still further, the polymerization processes that can be carried out in carbon dioxide medium may be expanded. The study on emulsion or microemulsion polymerization in carbon dioxide has been receiving considerable interest during last decades. The main issue is the difficulty to find inexpensive and efficient emulsifier or surfactants that can be used in carbon dioxide. By adding carbon dioxide expanded solvents, such as some polar organic solvents, in the system, the solvent strength may be largely tuned to accommodate some current commercially available surfactants or reagents.

Moreover, certain polymerization parameters, such as polymerization rate, may be tuned using carbon dioxide expanded solvent system. It is well known in the art that the initiation rate of some radical initiators, such as AIBN, is usually slower, while the initiation efficiency might be higher in carbon dioxide than in regular organic solvents, a property may be used to tune the polymerization rate in real time by adjusting the ratio between carbon dioxide to expanded solvents. Specifically, higher expanded solvent ratio may speed up the polymerization rate without the need to raise the temperature which is usually used.

‘Fluoromonomer’ as used in this application, has its conventional meaning and includes any suitable fluoromonomer known in the art. Specifically, it includes, but is not limited to, fluoroolefins, fluorinated vinyl ethers, fluoroacrylates, fluorostyrenes, fluoroalkylene oxide oligomers and others that can undergo free-radical polymerization to make fluoropolymers. By ‘fluoro’ or ‘fluorinated’ is meant that the monomer contains at least one vinylic fluorine atom, or a fluorinated alkyl group, or fluorinated alkoxy group attached to the vinyl group. The monomer may contain only carbon and fluorine, as is usually called perfluorinated compound, or contains hydrogen and other halogens. It may also contain oxygen, nitrogen, sulfur, phosphorous and any other possible elements which are termed as heteroatoms in this invention. Fluorination may also directly occur on the heteroatoms such as sulfur, phosphorous and nitrogen.

By fluoroolefin is meant that the vinyl group contains at least one vinylic fluorine atom. Those fluoroolefins that are useful in this invention should be able to polymerize either alone or with other monomers in presence of free radical initiators or under thermal, photochemical and any other possible conditions for free-radical polymerizations and include, but are not limited to, vinyl fluoride (VF), vinylidene fluoride (VF2 or VDF), trifluoroethylene, tetrafluoroethylene (TFE), chlorotrifluoroethylene (CTFE), 1,2-dichlorodifluoroethylene, hexafluoropropylene (HFP), other perfluoroalkyl ethylenes of 4 to 8 carbon atoms such as perfluorobutyl ethylene (PFBE), and semi-fluorinated alkylethylenes such as 3,3,3-trifluoropropene, 2-trifluoromethyl-3,3,3-trifluoro-1-propene and hexafluoroisobutylene. The fluoroolefin may also contain heteroatoms as mentioned above. For example, those with an oxygen atom not being directly attached to the vinyl group are also included. Otherwise, it will be included in fluorinated vinyl ethers. A number of other fluoroolefins are well known in the art.

Fluorinated vinyl ether usually denotes a fluoromonomer with one or more oxygen atom directly attached to the vinyl group. Some of the vinyl ethers are very useful monomer or comonomer in commercial fluoropolymers. The fluorinated vinyl ethers that are useful in this art may be either perfluorinated or semi-fluorinated. Fluorination may occur on vinyl group or side chains. Preferred fluorinated vinyl ethers in this invention have perfluorinated or partially fluorinated vinyl groups. They may contain any possible functionality including one or more other unsaturated bonds. Specifically, it includes, but not limited to, perfluoro(alkyl vinyl ether)s (PAVE) of 1 to 6 side chain carbon atoms such as perfluoromethyl vinyl ether (PMVE), perfluoroethyl vinyl ether (PEVE), perfluoropropyl vinyl ether (PPVE), perfluoro or semi-fluorinated (1,3-dioxole)s such as perfluoro(2,2-dimethyl-1,3-dioxole) (PDD), CF₂═CFOCF₂CF(CF₃)OCF₂CF₂X, CF₂═CFOCF₂CF₂X (X═SO₂F, SO₃H, SO₂N(H)SO₂R_{f}, CO₂H, CO₂CH₃, CH₂OH, CH₂OCN or CH₂OPO₃H), CF₂═CFO(CF₂)ₙCF═CF₂, CF₂═CFO—X—OCF═CF₂ (X=alkyl or aromatic group) and semi-fluorinated equivalents. Fluoromonomers with heteroatoms being directly attached to the oxygen such as CXY═CZOSF₅ (X, Y, Z=F, H and other halogens) are also included. Preferred fluorinated vinyl ethers in this invention should have at least one vinylic fluorine atom.

Fluorostyrenes, as used in the invention, contain either vinylic fluorine or aromatic fluorine atom or fluorinated side chain or any combination. By ‘fluorinated’ is meant either perfluorinated or semi-fluorinated. Useful fluorostyrenes in this invention include, but are not limited to, α-fluorostyrene, βfluorostyrene, α,β-fluorostyrene, β,β-fluorostyrene, α,β,β-fluorostyrene, α-trifluoromethylstyrene, 2,4,6-tris(trifluoromethyl)styrene, 2,3,4,5,6-pentafluoro styrene, 2,3,4,5,6-pentafluoro-α-methylstyrene, 2,3,4,5,6-pentafluoro-β-methyl styrene and styrenes with longer hydrocarbon or fluorocarbon side chains or any other functionality. Preferred fluorostyrenes in this art will have at least one fluorine atom directly attached to vinyl group.

Fluoroacrylates, as used herein, are fluorinated derivatives of acrylic acid, methacrylic acid as well as their esters. Fluorination could occur either on vinyl group or on side chain or both. However, partial- or per-fluorination on vinyl group is preferred in this art. The monomers are either perfluorinated or semi-fluorinated. Useful fluoroacrylates in this invention include, but are not limited to, vinylic fluoroacylates such as α-fluoroacrylate, β-fluoroacrylate, α,β-fluoroacrylate, β,β-fluoroacrylate and α,β,βfluoroacrylate, semi- or per-fluorinated methacrylates; acrylates or methacrylates with hydrocarbon or fluorocarbon side chains. Many specialty acrylates or methacrylates have been described in other places such as in U.S. Pat. No. 5,922,833 to DeSimone. These acrylates are also useful in this invention.

The fluoromonomer may homopolymerize into homopolymer or copolymerize with one or more other fluoromonomers into copolymers. By the terms “copolymer” or “copolymerization” in this application are meant that two or more monomers are involved. The copolymerization may also involve one or more hydrocarbon monomers in presence of at least one fluoromonomer. Those skilled in the art will know there are a wide variety of hydrocarbon monomers that can be used to copolymerize with fluoromonomers. Some specific examples of suitable hydrocarbon monomers in this invention include, but are not limited to, vinyl monomers such as ethylene, propylene, butene, vinyl chloride; dienes such as isoprene, chloroprene and butadiene; acrylic monomers including acrylic acid, methacrylic acid and their variety of esters, acrylamides, styrenics such as styrene, substituted styrenes; vinyl acetate, acrylonitrile, vinyl ethers, maleic anhydride More hydrocarbon monomers are included in Polymer Handbook, (J. Brandrup et al. Eds., 3^{rd} Ed. 1989) (Wiley-Interscience Division of John Wiley & Sons).

The present invention is suitable to manufacture a wide variety of fluoropolymers made from free radical polymerization including all the current commercially available fluoropolymers of the type and many novel ones having promising applications and potential markets. The term ‘fluoropolymer’, as used in this invention, is intended to include a broad spectrum of thermoplastic and elastomeric polymers comprising at least one fluoromonomer repeating unit. Specifically, it includes, but is not limited to, any homopolymer of the above fluoromonomers and the copolymer among two or more above fluoromonomers as well as between one or more above fluoromonomers with one or more above regular hydrocarbon monomers. Some commercial fluoropolymers are well known in the art and can be seen in many patents. Some typical examples are tetrafluoroethylene/hexafluoropropylene, tetrafluoroethylene/hexafluoropropylene/vinylidene fluoride, hexafluoropropylene/vinylidene fluoride, perfluoro(methyl vinyl ether)/vinylidene fluoride, perfluoro(methyl vinyl ether)/vinylidene fluoride/tetrafluoroethylene, chlorotrifluoroethylene/vinylidene fluoride, chlorotrifluoroethylene/ethylene, chlorotrifluoroethylene/tetrafluoroethylene/ethylene, tetrafluoroethylene/perfluoro(propyl vinyl ether), tetrafluoroethylene/perfluoro(methyl vinyl ether), tetrafluoroethylene/perfluoro(2,2-dimethyl-1,3-dioxole), tetrafluoroethylene/hexafluoropropylene/perfluoro(propyl vinyl ether), tetrafluoroethylene/ethylene, tetrafluoroethylene/propylene, tetrafluoroethylene/CF₂═CFOCF₂CF(CF₃)OCF₂CF₂SO₂F, tetrafluoroethylene/CF₂═CFOCF₂CF₂SO₂F, Tetrafluoroethylene/CF₂═CFO(CF₂)ₙ, CF═CF₂, tetrafluoroethylene/CF₂═CFO(CF₂CF₂CF₂O)SₙO₂F, polytetrafluoroethylene, poly(chlorotrifluoroethylene), poly(vinylidene fluoride), poly(vinyl fluoride) and the like.

Polymerization in heterogeneous medium of aqueous and carbon dioxide phase may be a conventional dispersion polymerization if sufficient amount of dispersant is used or the resulting polymer is self-emulsified, or may be a suspension polymerization if no or little dispersant is used.

Polymerization carried out in homogeneous medium of carbon dioxide and expanded solvent may be a conventional solution polymerization, suspension polymerization or dispersion polymerization. In solution polymerization, the resulting polymer could be soluble in the reaction medium such as some polyacrylates, or be insoluble in the reaction medium and precipitate out which is also called precipitation polymerization. In suspension polymerization, dispersant may, or may not, be employed. The suspension is provided by a fast agitation and with or without the assist of a small amount of dispersant or stabilizer. In dispersion polymerization, a relatively large amount of dispersant is used, and the agitation is relatively slow but fast enough to prevent the coagulation of the resulting emulsion. The switch from one type of polymerization to another type may be performed by adding a certain amount of a dispersant, but also through adjusting the type and the ratio of the expanded solvent relative to carbon dioxide.

The present invention contemplates two types of polymerization media and polymerization processes therein. The first type is a heterogeneous medium comprising an aqueous phase and a carbon dioxide phase, and the polymerization may be used as an alternative to the conventional suspension and dispersion polymerization. It is well known in the art that dense carbon dioxide can measurably plasticize most polymers, especially amorphous and some semi-crystalline polymers. The morphology, glass transition, surface energy and various other physical properties of plasticized polymers usually are greatly changed. Therefore, the interfacial tension between some plasticized fluoropolymers and aqueous phase may be reduced which makes using dispersant other than fluorinated surfactants possible without dramatically degrading the emulsification, polymer properties and stability of the resulting polymer latex. It is also well known that hydrocarbon surfactants usually either are not effective in polymerization of fluoromonomers or can cause excessive chain transfer so that the polymerization rate and molecular weight of the resulting polymers can be dramatically decreased. No polymerization takes place or only oligomers can be produced in some extreme situations, so using non-fluorinated surfactants in industrial fluoromonomer polymerization is very rare. It is demonstrated in this invention that by using carbon dioxide as emulsification aid, carefully choosing the non-fluorinated surfactant and delicately keeping reasonable ratio balance between dispersant and monomers, a dispersion polymerization using non-fluorinated dispersant can be achieved successfully.

The carbon dioxide phase in the heterogeneous medium of this invention may be in gas, liquid, supercritical and sub- or near-critical state. Those skilled in the art will know that every gas has a critical temperature as well as a critical pressure above either of which the gas can not be liquefied. In the case of carbon dioxide, the critical temperature is approximately 31° C. and the critical pressure is approximately 1100 psi (73.8 bar). The sub-critical state, also called near-critical state, is specified as in a region of approximately 1.05 to 1.2 times of critical temperature and 0.9 to 2.0 times of critical pressure. The ratio of carbon dioxide phase to aqueous phase as well as the physical state of carbon dioxide in a specific polymerization is usually dependent on the type of fluoropolymer targeted. Amorphous fluoropolymer is usually more easily plasticized by carbon dioxide so that the effective amount of carbon dioxide is also less. Specifically, the ratio between aqueous phase to carbon dioxide phase could be between 1:99 to 99:1 by volume. More specifically, 10:90 to 90:10 ratio by volume is preferred.

The second type of the polymerization media contemplated for this invention is a homogeneous mixture of an organic solvent phase and a carbon dioxide phase. The carbon dioxide phase may be in a gaseous, liquid, supercritical or subcritical state. The medium may be called carbon dioxide expanded solvent medium if the amount of organic solvent is significant. It may also be called solvent mixture if carbon dioxide is in majority. However, if too little organic solvent is added, the tuning ability of the solvent is limited and the desired properties of the solvent mixture may not be reached.

Carbon dioxide expanded medium was once used as gas anti-solvent process (GAS) in crystallization of sensitive materials such as pharmaceuticals and biological products at moderate temperature. It is currently being pursued in catalytic oxidation of organic compounds using transition metal complexes as well as some other organic reactions. See, for example, U.S. Pat. No. 6,448,454 B1 to Subramaniam et al., which discloses a multi-phase media containing an organic solvent expanded by supercritical or subcritical carbon dioxide in catalytic oxidation reaction of organic substrates by transition metal complexes. The medium has higher solubility to the oxidizer, dioxygen, and higher reaction temperature limits and eventually improves the substrate conversion and product selectivity. Moreover, the solvent system addresses the environmental concerns and safety issues in the related manufacturing industry based on the organic solvents and provide a more economic and environmental friendly medium.

It is well known in the art that polymerization of fluoromonomers is often difficult in some aspects compared with hydrocarbon monomers, especially when carried out in regular hydrocarbon organic solvents where excessive chain transfer usually occurs in the presence of fluorinated propagating radicals. This often causes low polymerization rate, low yield and small molecular weight of the resulting polymer. See, for example, the systematic studies on chain transfer of some hydrocarbon compounds or solvents in the presence of some fluoroalkyl radicals discussed by Dolbier in Chem. Rev. 1996, 96, 1557-1584 and Shtarev et al in J. Am. Chem. Soc. 1999, 121, 7335-7341. Polymerization of fluoromonomers is rarely performed in a per-hydrogenated solvent or even in their presence. The organic solvents that are usually used as reaction medium are a so called non-telogenic solvents such as chlorofluorocarbons and perfluorocarbons. More environmentally friendly replacements of these solvents, such as hydrochlorofluorocarbons and hydrofluorocarbons may also be used sometimes. There are a limited number of hydrocarbon compounds that have very low chain transfer constants and have been used in the polymerization, such as some simple organic acids as disclosed in U.S. Pat. No. 4,186,121 to Gangal, some grades of paraffin waxes as taught by U.S. Pat. No. 2,612,484 to Bankoff and some hydrofluorcarbon solvents as disclosed by U.S. Pat. No. 5,182,342 to Feiring et al. However, many more hydrocarbon organic compounds are usually used as chain transfer agents to tune down the molecular weight of fluoropolymers. This even includes some hydrofluoroethers such as those disclosed in U.S. Pat. No. 6,399,729 B1 to Farnham et al. Japanese Patent Application 1/151,293 states that the groups —CH₂F and —CHF₂ have ‘substantial’ chain transfer constants to fluoroalkyl radicals generated in polymerization.

In the present invention, some regular hydrocarbon organic solvents as well as hydrofluorocarbons and hydrofluoroethers or any mixture thereof are used as co-solvent or expanded solvent in the polymerization of fluoromonomers. Suitable solvents in this invention range from hydrocarbon to halogenated solvents, polar to non-polar, and/or acidic to basic with various functionalities. By changing solvent, tuning ratio and matching co-solvents, the resulting medium after mixing with carbon dioxide may have a very board spectrum of physical properties, so any type of polymerization may be performed in the medium such as solution, precipitation, suspension and dispersion polymerization.

The useful solvents in this invention have very low chain transfer constants and are compatible with carbon dioxide at the same time. By slowly mixing the solvent with carbon dioxide or adding carbon dioxide in the reactor, the drastic expansion of the solvent volume can be easily noticed. Suitable hydrocarbon solvents include, but are not limited to, alkanes such as methane, ethane, cyclopetene, cyclohexane, n-heptane and cumene, organic acids such as formic, acetic, malonic, succinic, adipic, citric, glutaric and hydroxyacetic acids, alcohols such as methanol, ethanol, t-butyl alcohol and ethylene glycol, ketone such as acetone and methyl t-butyl ketone, ethers such as dimethyl ether, diethyl ether, dimethoxy methane, 1,2-dimethoxy ethane, THF, 1,4,-dioxane, 1,3,5-trioxane, 1,3-dioxolane and 2,2-dimethyl-1,3-dioxolane, organic chloride such as chloroform, dichloromethane, carbon tetrachloride and 1,2-dichloroethane, aromatic such as benzene, toluene, mesitylene, naphthalene and NMP, esters such as methyl acetate and ethyl acetate, other solvents such as acetonitrile, DMSO and cyclohexanone, and any mixture thereof. Preferred hydrocarbon solvents are methane, formic acid, acetic acid, methyl acetate, DMSO and acetone. Suitable perfluorocarbons include, but not limited to, perfluoroalkanes from 1 to 8 carbons, cycloalkanes such as perfluorobutane, perfluoropentene and perfluorohexene, perfluoropolyethers (PFPE) with —CF₂—, —CF₂CF₂—, —CF₂CF(CF₃)—, —CF₂CF₂CF₂— repeating units or any mixtures of them, perfluorobenzene, perfluorotoluene, SF₆, CF₃SF₅ and N(C₄F₉)₃. Preferred perfluorocarbons are SF₆, CF₄, CF₃CF₃ and other perfluoroalkanes. Suitable hydrofluorocarbons include, but not limited to, CF₃CH₂CF₂CH₃, CF₃CFHCFHCF₂CF₃, CF₃CH₂CF₃, CF₃CFHCF₃, CF₃CH₂CH₂CF₂CF₃, 1,1,2,2,-tetrafluorobutane, H(CF₂)ₙH and H(CF₂)ₙCF₃, trifluoromethyl toluene, 1,3-bis(trifluoromethyl)benzene. Preferred hydrofluorocarbons are CF₃CH₂CF₂CH₃, CF₃CFHCFHCF₂CF₃, CF₃CH₂CF₃, trifluoromethyl toluene and 1,3-bis (trifluoromethyl)benzene. Any hydrofluorocarbons with more than two adjacent CH₂ group should be avoided. Suitable hydrofluoroethers include, but not limited to, CH₃OCF₃, CH₃OCF₂CF₃, CH₃OC₃F₇, CH₃OC₄F₉, CH₃OCF₂CFHCF₃, CH₃OCF₂CF₂H, CF₃OCHFCF₃ and CF₃OCH₂CF₂CF₃. Preferred hydrofluoroethers are CH₃OCF₃, CH₃OCF₂CF₃, CH₃OC₃F₇, CH₃OC₄F₉, CF₃OCHFCF₃ or the ones without any hydrogen atoms on the carbon adjacent to the ether oxygen atoms. Hydrofluoroethers with more than two hydrogen atoms on the carbons adjacent to the ether oxygen atoms except a methyl group should be avoided. Any two or more of above solvents can be used as a mixture if compatible.

Most of the above solvents except perfluorocarbons will have a certain degree of chain transfer under some conditions. The preferred structures that can be used in this invention are limited due to the high chain transfer constants associated with certain structures. Thus, if one solvent or solvent mixture is selected, it may be one which causes minimum chain transfer or earlier termination given that other requirements for the solvent are met. Some factors, such as the type of fluoromonomer, the ratio of the solvent to carbon dioxide, polymerization temperature and the type of polymerization process, may all be considered before a solvent is selected. To those skilled in this field, it should not be very difficult.

The success of the process will be dependent on an appropriate selection of solvent, ratio between solvent to carbon dioxide as well as some other factors. The optimum solvent and solvent ratio are always associated with specific polymer and polymerization system. Generally, the ratio between solvent to carbon dioxide may range from 1/99 to 99/1 by volume. Preferably, the ratio ranges from 10/90 to 90/10 by volume. Most preferably, solvent to carbon dioxide is 40/60 to 10/90 by volume. Carbon dioxide is generally preferred to be used as a major component in this invention in consideration of chain transfer, cost and environmental issues.

In the present invention, the fluoromonomers or hydrocarbon monomers may be homo- or co-polymerized in the presence of radical polymerization initiators, including any inorganic and organic, water-soluble, oil-soluble and carbon dioxide soluble initiators such as, but not only, those listed in Polymer Handbook, II/1-II/65 (J. Brandrup et al. Eds., 3^{rd} Ed 1989) (Wiley-Interscience Division of John Wiley & Sons). The initiator is usually soluble in the corresponding polymerization medium.

In heterogeneous medium comprising water and carbon dioxide, with or without surfactants, water soluble free radical initiators are preferred. This includes thermal radical initiators, redox initiator systems or their combination. Suitable thermal radical initiators are usually peroxides such as disuccinic acid or metal persulfates such as potassium persulfate. The suitable initiator systems include any pair of matching oxidizing and reducing agent known in the art. Useful oxidizing agents of redox initiator systems in this invention include, but are not limited to, metal persulfates such as potassium persulfate and ammonium persulfate, peroxides such as hydrogen peroxide, ammonium peroxide, potassium peroxide, cumene hydroperoxide, tertiary hydroperoxide, and tertiary amyl hydroperoxide, manganese triacetate, potassium permanganate, ascorbic acid and any possible mixtures thereof. Suitable reducing agents could be, but are not limited to, sodium sulfites such as sodium bisulfite, sodium pyrosulfite, sodium sulfite, sodium-m-bisulfite, ammonium sulfite monohydrate, sodium thiosulfate, hydrazine, hydroxylamine, ferrous iron. There are some organic acids that could also be used as reducing agents such as oxalic acid, malonic acid, citric acid and any of their mixtures. The preferred initiator is dependent on the type of the specific fluoromonomer or monomer pair, targeted molecular weight, molecular weight distribution and grades of fluoropolymer. In some embodiments, the metal persulfate such as potassium or ammonium persulfate is used.

In the medium comprising expandable solvents and carbon dioxide, initiator is either compatible with organic solvents, so called oil-soluble initiator, or soluble in carbon dioxide phase or soluble in the expanded solvents. It may also be insoluble in the above media. The addition of this type of initiator will need the assistance of another solvent or solvent mixture which can dissolve the initiator and, at the same time, is compatible with the above media. The amount of the solvent should be less in order not to noticeably affect the polymerization medium. Inorganic initiators may also be added in case of the polarity of the combined solvent is relatively high. Suitable initiator could be either fluorinated initiators or hydrocarbon initiators. Fluorocarbon initiators include, but not limited to, diacyl or dialkyl peroxide such as hexafluoropropylene oxide (HFPO) dimer peroxide (3P), perfluorobutylacyl peroxide, perfluoropropionyl peroxide, semi-fluorinated peroxide with formula CₙF₂ₙ₊₁(CH₂)ₐCF₂(C═O)OO(C═O)CF₂(CH₂)_{b}CₘF₂ₘ₊₁, perfluoroisopropane, hexafluoropropylene trimer radical and other fluorinated peroxides discussed in the EU Pat. No. 1157988 A2 and 1164130 A2 to Brothers et al. and by H. Sawada, Chem. Rev. 1996, 96, 1557-1584. They could also be some high temperature thermal initiators such as NF₃, R_{f}NF₂, (R_{f})₂NF, (R_{f})₃N, RN═NR, R_{f}OOR_{f}, R_{f}I, R_{f}SSR_{f} and (R_{f})₂NSR_{f}. Preferred fluorocarbon initiator is HFPO dimer peroxide. Hydrocarbon initiators could be azo-nitriles, alkyl or acyl peroxide, ketone peroxide, peresters and peroxy carbonates. Useful hydrocarbon initiators in this invention include, but not limited to, diacyl peroxide, trichloroacyl peroxide, acetyl peroxide, benzoyl peroxide, succinic acid peroxide, dialkyl peroxide, ethylhexylperoxy dicarbonate, di-t-butyl peroxide, dicumyl peroxide, t-butyl peroxide, cumylperoxide, peroxydicarbonates, di(sec-butyl) peroxydicarbonate, 1,1-dimethyl-3-hydroxybutylperoxyneoheptanoate, t-butyl peroxyacetate, acetylcylclohexanesulfonyl peroxide, diacetyl peroxydicarbonate, dicyclohexyl peroxydicarbonate, di-2-ethylhexyl peroxydicarbonate, t-butyl pemedecanoate, 2,2′-azobis(2,4-dimethylvaleronitrile), 2,2′-azobis(isobutyronitrile), 2,2′-azobis(methoxy-2,4-dimethylvaleronitrile), 2,2′-azobis(isobutyronitrile), p-menthane hydroperoxide, diisopropylperoxy dicarbonate, t-butyl hydroperoxide, t-butyl perpivalate, dioxtanoyl peroxide, dilauroyl peroxide, t-butylazo-2-cyanobutane and mixtures thereof. Preferred hydrocarbon initiators include 2,2′-azobis(isobutyronitrile) (AIBN), di-2-ethylhexyl peroxydicarbonate, dilauroyl peroxide, diisopropylperoxy dicarbonate, t-butyl hydroperoxide, di-t-butyl peroxide and dicumyl peroxide.

The initiator may be added prior to initiation of polymerization batchwise or may be added in increments during the polymerization. It may be in neat form if it is a liquid or as a solution in an organic solvent or solvent mixture. The solvent should be non-telogenic or will not cause excessive chain transfer in the amount used therein. The concentration of the solution is not critical but should be correlated with its chain transfer constants. The solvents include, but are not limited to, any non-telogenic hydrocarbon solvent, perfluorcarbon, hydrofluorocarbon and hydrofluoroether solvent.

The amount of the initiator will be dependent on the specific conditions used such as the specific medium, monomer or monomer pair, targeted molecular weight, molecular weight distribution and the grades of fluoropolymers. Generally, the initiator may be added in an amount of 1 ppm to 10 parts based on the 100 parts monomer or co-monomers by weight, preferably 10 ppm to 2 parts.

The polymerization of fluoromonomers in the heterogeneous medium comprising an aqueous phase and a carbon dioxide phase may be carried out with or without dispersants. By “dispersant” is meant surfactant, or sometimes called “emulsifier” or stabilizer, as well as inorganic dispersion stabilizer. Any suitable non-fluorinated non-telogenic dispersant in the art may be employed in this medium. Typical surfactants include small molecular and polymeric surfactants, hydrocarbon and silicon, anionic, cationic, zwitterionic and non-ionic surfactants. Typical polymeric surfactants include, but are not limited to, poly(vinyl alcohol), hydroxyl propyl cellulose, methyl cellulose, carboxymethyl cellulose and its various metal salts, sodium(styrene sulfonate), poly(ethylene oxide), alkali metal salts of poly (acrylic acid). Useful anionic surfactants include, but are not limited to, fatty acid soaps such as sodium or potassium stearate, laurate, palmitate, sulfonates, sulfates. Suitable non-ionic surfactants include, but are not limited to, pluronic family, SPAN™ family, TWEEN™ family, those with general formula, R¹—O—[CH₂CH₂O]ₙ—[R²O]ₘR ³ such as poly(propyleneoxide)-g-poly(ethylene oxide), TRITON™ and GENAPOL®. Examples of cationic surfactants include but not limited to dodecylammonium chloride and acetyltrimethyl ammonium bromide. Useful silicon surfactants include, but are not limited to, a variety of derivatives of polysiloxanes. Inorganic emulsion stabilizers include, but are not limited to, bentonite, talc, and diatomaceous earth. Preferred dispersants are non-telogenic or having very low chain transfer constants. More preferably, methyl cellulose, carboxymethyl cellulose and its alkali metal salts, bentonite, talc, and diatomaceous earth are usually used.

The amount of dispersant may be depending on the targeted properties of the polymer emulsion or latex or slurry and the chain transfer constants of the specific dispersant. For dispersant with relatively high chain transfer constant, the amount that can be applied will be limited. Without or with very little dispersants, the polymerization should be a suspension polymerization. Otherwise, it is a dispersion polymerization. The amount of the dispersant should be as little as possible provided the effective stabilization can be achieved. For those polymerizations in the absence of dispersant, they could be either a suspension polymerization or a dispersion polymerization with self-emulsification. Suspension polymerization should be run with a fast agitation while dispersion polymerization may only be applicable to certain polymers which are associated with certain ionic initiators or fluoromonomers that can provide self-emulsification. These polymers may include, but are not limited to, PCTFE or copolymers of chlorotrifluoroethylene, PVDF and its various copolymers.

Dispersion polymerization may also be performed in the homogeneous medium of expanded solvent and carbon dioxide. No dispersant specially designed for the medium is commercial available. However, construction of the dispersant for specific carbon dioxide and expanded solvent may be performed. Some polymer segments that are soluble in carbon dioxide include, but are not limited to, polyalkene oxides, perfluorinated polypropylene oxide, polymethyl acrylate, polyvinyl acetate, polyalkyl siloxanes, and polyether carbonates. In the presence of expanded solvent, the solubility of the polymers with above segments may be changed, so the design should also change accordingly. Some research on this may be available in publications. See, for example, the review by G. Sadowski in Supercritical Carbon Dioxide, p 15-35 (M. Kemmere et al. Eds. 2005) (Wiley-VCH).

The amount of dispersant is dependent on the type of polymer, the targeted size and morphology of polymer particles, molecular weight and the type of polymerization process. Usually no or very little dispersant is needed in suspension polymerization. In dispersion polymerization, generally, 0.001-3 parts of dispersant by weight per 100 parts of the medium may be applied. Preferably, 0.01-1 part of dispersant is usually used.

The polymerization may include other necessary additives such as chain transfer agents (CTA), buffers and stabilizers for emulsion or suspension other than the major dispersants applied. Chain transfer agents may or may not be added. Mostly, in homogeneous medium, the expanded solvent with hydrogen atoms will provide enough control over molecular weight of resulting polymers. The hydrocarbon surfactant added in some polymerizations in heterogeneous medium of carbon dioxide and aqueous phase may also provide enough control over the molecular weight of the resulting polymer. In the cases where outside chain transfer agents is added, it will be from some commonly used CTA such as methanol, alkanes, alcohols, ethyl or butyl mercaptan, butyl sulfide, alkyl iodide, alkyl bromide or certain hydrofluoroethers. Buffer may be needed in the heterogeneous medium of carbon dioxide and aqueous phase. Buffers include formic, acetic, malonic, succinic, adipic, citric, glutaric and hydroxyacetic acids. Some emulsion stabilizer may be also added in the heterogeneous medium. Usually paraffin wax with melting temperature ranging from 47-65° C. is added. Paraffin wax that melts from 54-62 is typically used.

The polymerization in heterogeneous medium of carbon dioxide and aqueous phase may be performed at a temperature of about −20° C. up to 100° C. A co-solvent for lowering the temperature of aqueous phase maybe added such as some alcohols. Preferably, the polymerization temperature ranges from 10 to 80° C. The polymerization in homogeneous medium may be carried out at a temperature ranging from −50 to 200° C., or even higher in some cases such as those for preparation of some grades of HFP. A more typical range is from −20° C. to 150° C. The most used range is from 20 to 80° C.

The polymerization may be carried out at a pressure from 15 psi up to 45,000 psi. Preferably, the polymerization pressure ranges from 50-1000 psi in heterogeneous medium and 600 psi to 10,000 psi in homogenous medium comprising carbon dioxide and expanded solvent.

The type, form and size of polymerization vessel are not very critical in the present invention. The polymerization in both medium may be carried out batchwise, semi-continuous and continuous in any commonly used or specially designed high pressure reaction vessel. Cooling or heating of the reactor should be provided. Any stirrer such as paddle stirrer, impeller stirrers, or multistage impulse countercurrent agitators and blades may be used.

The separation of the polymer obtained from polymerization using the mediums of this invention may be compatible to many common separation methods. For the polymers made in heterogeneous medium of aqueous and carbon dioxide phase, the venting of carbon dioxide and some unreacted monomers is usually performed first. Then the obtained polymer latex or slurry will be coagulated, filtered, washed and dried in vacuum oven. The polymers obtained in homogeneous medium of carbon dioxide and expanded solvent can be worked up based on the specific polymerization process. Usually when the polymerization is solution, precipitation or suspension polymerization without dispersant, carbon dioxide along with unreacted monomers and some solvent is vented first. If the co-solvent is very volatile, a solid polymer either as free-flowing powder, gum or chunk is obtained directly. Otherwise, the solvent should be rotavoped and then vacuum dried in vacuum oven at elevated temperatures. In some cases, it may involve refilling the reactor with dense carbon dioxide multiple times followed by venting to remove certain reagents. When the polymerization is a dispersant polymerization, a dispersant extraction is performed directly following the carbon dioxide venting. Usually a polar, high boiling solvent is used therein, so extraction with Freon 113/methanol or Vertrel XF/methanol is carried out directly before being dried. For all the other polymers except those obtained in dispersion polymerization, a post removal of impurities, such as additives leftover, initiator derivatives and low molecular weight molecules, may be performed. For those obtained in larger scale continuous process, a suitable standard industrial separation may be performed.

The fluoropolymers produced in the media and processes of this invention may be a thermoplastic or an elastomer in various forms for the current commercial fluoropolymers, and so are potentially able to be used in all the applications and fields that the conventional polymer grades serve. Specifically, they may be used in medical and food industry, in commodity products, in industrial processes or as high performance and heavy duty materials such as wire coatings, gaskets, seals, hoses, vessel linings, optical materials, pellicles, gas separation membranes, fuel cell membranes, elastomer, molded resins, protective coatings, textile coatings, and the like.

Polymerizing steps as described herein are preferably carried out at a pressure suitable for commercial polymerizing equipment. The particular upper pressure limit will vary depending upon the equipment in which the process is implemented and the particular polymer being produced, but in certain embodiments, is not greater than 2400 psi, not greater than 2000 psi, not greater than 1800 psi, not greater than 1600 psi, or not greater than 1400 psi.

“Essentially free” of fluorosurfactant means that the level of environmentally objectionable fluorosurfactant (e.g., fluorosurfactants that bioaccumulate) in the polymerization medium is reduced to environmentally and/or toxicologically acceptable limits. For example, in some embodiments the polymerization medium (or the polymer separated therefrom) may contain less than 200, less than 100, less than 50, less than 10, less than 5, or less than 1 ppm of environmentally objectionable fluorosurfactants.

Those skilled in the art will appreciate that the present invention can be implemented in a variety of ways, including but not limited to the incorporation of features, materials, elements, ranges, etc. as described in: U.S. Pat. No. 2,559,752 to Berry, 3,271,341 to Garrison; U.S. Pat. No. 4,380,618 to Kahn et al; U.S. Pat. No. 4,864,006 to Giannetti et al; U.S. Pat. No. 5,789,508 to Baker et al; U.S. Pat. No. 3,316,201 to Hahn et al, U.S. Pat. No. 3,037,953 to Marks et al.; U.S. Pat. No. 4,369,266 to Kuhls et al. ; U.S. Pat. No. 3,882,153 to Seki et al or U.S. Pat. No. 4,282,162 to Kuhls U.S. Pat. Nos. 20030220442 A1 and 20040143052 A1 to Epsch et al; U.S. Pat. No. 6,861,466 B2 to Dadalas et al; U.S. Pat. No. 20050189299 A1 and 20060148973 A1 to Malvasi et al; U.S. Pat. No. 5,824,755 to Hayashi et al.; U.S. Pat. No. 6,277,937 B1 to Duvalsaint; U.S. Pat. No. 5,496,901 to DeSimone; U.S. Pat. No. 5,981,673 to DeSimone; U.S. Pat. No. 5,824,726 to DeSimone et al; and U.S. Pat. No. 6,051,682 to Debrabander et al. The disclosures of all United States patent references cited herein are to be incorporated by reference herein in their entireties.

The following examples are simply provided to demonstrate the present invention, so should not be considered as the whole invention by itself or any kind of self-limiting. In these examples, ‘psi’ means pounds per square inch; ‘g’ means grams; ‘ml’ means milliliters; ‘° C.’ means degree Celsius; ‘TFE’ means tetrafluoroethylene; ‘PTFE’ means polytetrafluoroethylene; ‘HFP’ means hexafluoropropylene; ‘PPVE’ means perfluoro(propyl vinyl ether); ‘PMVE’ means perlfuoro(methyl vinyl ether); ‘VDF’ means vinylidene fluoride; ‘PEVE-Br’ means perfluoro(2-bromoethyl vinyl ether), ‘VF’ means vinyl fluoride and ‘DMSO’ means dimethyl sulfoxide. Molecular weight of PTFE is estimated based on the heat of crystallization of Differential scanning calorimetry using the method described in T. Suwa, et al., J. Applied Polymer Sci., 1973, 17, 3253. Some molecular weights are below 5.2×10⁵ g/mol and only presented as rough estimations.

### EXAMPLE 1

### TFE Homopolymerization in Acetic Acid/Carbon Dioxide

A 25 ml high pressure reactor cell is purged with liquid carbon dioxide three times to remove air. Acetic acid (3.5 ml), pre-purged with Argon, is added into the cell under positive pressure of Argon, and the reactor is resealed. A mixture of 50/50 by weight tetrafluoroethylene and carbon dioxide (2.9 g) is charged into the reactor cell through high pressure syringe pump. The reactor is then slowly heated to 35° C. A 0.204 M solution of hexafluoropropylene oxide dimer peroxide in 1,1,2-trichlorotrifluoroethane (0.006 ml) is injected into a gas addition tube with the protection of a positive Argon pressure, and the tube is resealed. Carbon dioxide is charged into the cell slowly through the gas addition tube and brings the initiator into the cell. The volume of the acetic acid is quickly expanded as more carbon dioxide is added in until the reactor is fully filled with expanded solvent, the pressure at the point is approximately 1000 psi. More carbon dioxide is added until the initial pressure is adjusted to approximately 2500 psi. The reaction is held for 4 hours before being cooled down to room temperature. The ending pressure is approximately 1850 psi. Carbon dioxide, excess tetrafluoroethylene and whatever volatile are slowly vented until the pressure reaches equilibrium with outside. The reactor is opened, the product, which is a white solid wetted with acetic acid, is collected. The product is washed with a mixture of 1,1,2-trichlorotrifluoroethane and methanol (1/1 by volume) three times and dried in a vacuum oven at elevated temperature. A white powder of approximately 0.93 g is obtained (63.7% yield). Thermogravimetric analysis gives a 5% loss at 514° C. Differential scanning calorimetry shows a melting temperature of 328.0° C. with a 10° C./min. heating rate. The second heating gives almost identical positions. The integration of the melting peak gives a heat of crystallization of 51.0 J/g corresponding to an estimated molecular weight of 52,000 g/mol.

### EXAMPLE 2

### TFE Homopolymerization in Acetic Acid/Carbon Dioxide

The same recipe and conditions are used as example 1 except that less carbon dioxide is added to just expand the acetic acid to the full volume of the cell. The reaction was run and worked up in a manner similar to that in sample 1.

### EXAMPLE 3

### TFE Homopolymerization in Acetone/Carbon Dioxide

A 25 ml high pressure reactor cell is purged with liquid carbon dioxide three times to remove air. Acetone (3.5 ml), pre-purged with Argon, is added into the cell under positive pressure of Argon, and the reactor is resealed. A mixture of 50/50 by weight tetrafluoroethylene and carbon dioxide (2.6 g) is charged into the reactor cell through high pressure syringe pump. The reactor is then slowly heated to 35° C. A 0.204 M solution of hexafluoropropylene oxide dimer peroxide in 1,1,2-trichlorotrifluoroethane (0.006 ml) is injected into a gas addition tube with the protection of a positive Argon pressure, and the tube is resealed. Carbon dioxide is charged into the cell slowly through the gas addition tube and brings the initiator into the cell. The volume of the acetone is quickly expanded as more carbon dioxide is added in until the reactor is fully filled with expanded solvent, the pressure at the point is approximately 960 psi. More carbon dioxide is added until the initial pressure is adjusted to approximately 2500 psi. The reaction is held for 4 hours before being cooled down to room temperature. Carbon dioxide, excess monomer, solvent and whatever volatile are slowly vented until the pressure reaches equilibrium with outside. The reactor is opened, the product, which is a white solid wetted with acetone, is collected. The product is washed with a mixture of 1,1,2-trichlorotrifluoroethane and methanol (1/1 by volume) three times and dried in a vacuum oven at elevated temperature. A white powder of approximately 0.23 g is obtained (17.4% yield). Thermogravimetric analysis gives a 5% loss at 387.7° C. Differential scanning calorimetry shows a melting temperature of 321.0° C. with a 10° C./min. heating rate. The integration of the melting peak gives a heat of crystallization of 55.1 J/g. However, the molecular weight is not estimated based on the data due to the apparent decomposition at the temperature range of melting.

### EXAMPLE 4

### TFE Homopolymerization in Dimethyl Sulfoxide/Carbon Dioxide

A 25 ml high pressure reactor cell is purged with liquid carbon dioxide three times to remove air. DMSO (3.5 ml), pre-purged with Argon, is added into the cell under positive pressure of Argon, and the reactor is resealed. A mixture of 50/50 by weight tetrafluoroethylene and carbon dioxide (2.88 ml, 2.68 g) is charged into the reactor cell through high pressure syringe pump. The reactor is then slowly heated to 35° C. A 0.204 M solution of hexafluoropropylene oxide dimer peroxide in 1,1,2-trichlorotrifluoroethane (0.006 ml) is injected into a gas addition tube with the protection of a positive Argon pressure, and the tube is resealed. Carbon dioxide is charged into the cell slowly through the gas addition tube and brings the initiator into the cell. The volume of the DMSO is quickly expanded as more carbon dioxide is added in until the reactor is fully filled with expanded solvent, the pressure at the point is approximately 980 psi. More carbon dioxide is added until the initial pressure is adjusted to approximately 2500 psi. The reaction is held for 4 hours before being cooled down to room temperature. Carbon dioxide, excess tetrafluoroethylene and whatever volatile are slowly vented until the pressure reaches equilibrium with outside. The reactor is opened, the product, which is a white solid wetted with DMSO, is collected. The product is washed with a mixture of 1,1,2-trichlorotrifluoroethane and methanol (1/1 by volume) three times and dried in a vacuum oven at elevated temperature. A light yellow powder of approximately 0.019 g is obtained (1.4% yield).

### EXAMPLE 5

### TFE Homopolymerization in HFC-365 mfc/Carbon Dioxide

A 25 ml high pressure reactor cell is purged with liquid carbon dioxide three times to remove air. HFC-365 mfc (CF₃CH₂CF₂CH₃) (3.5 ml), pre-purged with Argon, is added into the cell under positive pressure of Argon, and the reactor is resealed. A mixture of 50/50 by weight tetrafluoroethylene and carbon dioxide (2.60 ml, 2.41 g) is charged into the reactor cell through high pressure syringe pump. The reactor is then slowly heated to 35° C. A 0.204 M solution of hexafluoropropylene oxide dimer peroxide in 1,1,2-trichlorotrifluoroethane (0.006 ml) is injected into a gas addition tube with the protection of a positive Argon pressure, and the tube is resealed. Carbon dioxide is charged into the cell slowly through the gas addition tube and brings the initiator into the cell. The volume of the HFC-365 mfc is quickly expanded as more carbon dioxide is added in until the reactor is fully filled with expanded solvent, the pressure at the point is approximately 1000 psi. More carbon dioxide is added until the initial pressure is adjusted to approximately 2500 psi. The reaction is held for 4 hours before being cooled down to room temperature. The ending pressure is approximately 1600 psi. Carbon dioxide, excess monomer, solvent and whatever volatile are slowly vented until the pressure reaches equilibrium with outside. The reactor is opened, the product, which is a white solid wetted with BFC-365 mfc, is collected. The product is washed with a mixture of 1,1,2-trichlorotrifluoroethane and methanol (1/1 by volume) three times and dried in a vacuum oven at elevated temperature. A white powder of approximately 0.94 g is obtained (77.6% yield). Thermogravimetric analysis gives a 5% loss at 522.3° C. Differential scanning calorimetry shows a melting temperature of 327.2° C. with a 10° C./min. heating rate. The second heating gives almost identical positions. The integration of the melting peak gives a heat of crystallization of 44.7 J/g corresponding to an estimated molecular weight of 100,000 g/mol.

### EXAMPLE 6

### TFE Homopolymerization in HFC43-10mee/Carbon Dioxide

A 25 ml high pressure reactor cell is purged with liquid carbon dioxide three times to remove air. HFC-43-10mee (CF₃CHFCHFCF₂CH₃) (3.5 ml), pre-purged with Argon, is added into the cell under positive pressure of Argon, and the reactor is resealed. A mixture of 50/50 by weight tetrafluoroethylene and carbon dioxide (3.07 ml, 2.86 g) is charged into the reactor cell through high pressure syringe pump. The reactor is then slowly heated to 35° C. A 0.204 M solution of hexafluoropropylene oxide dimer peroxide in 1,1,2-trichlorotrifluoroethane (0.006 ml) is injected into a gas addition tube with the protection of a positive Argon pressure, and the tube is resealed. Carbon dioxide is charged into the cell slowly through the gas addition tube and brings the initiator into the cell. The volume of the HFC-43-10mee is quickly expanded as more carbon dioxide is added in until the reactor is fully filled with expanded solvent, the pressure at the point is approximately 1000 psi. More carbon dioxide is added until the initial pressure is adjusted to approximately 2500 psi. The reaction is held for 4 hours before being cooled down to room temperature. The ending pressure is approximately 1750 psi. Carbon dioxide, excess monomer, solvent and whatever volatile are slowly vented until the pressure reaches equilibrium with outside The reactor is opened, the product, which is a white solid wetted with HFC-43-10mee, is collected. The product is washed with a mixture of 1,1,2-trichlorotrifluoroethane and methanol (1/1 by volume) three times and dried in a vacuum oven at elevated temperature. A white powder of approximately 1.02 g is obtained (71.2% yield). Thermogravimetric analysis gives a 5% loss at 510.3° C. Differential scanning calorimetry shows a melting temperature of 326.5° C. with a 10° C./min. heating rate The second heating gives almost identical positions. The integration of the melting peak gives a heat of crystallization of 35.9 J/g corresponding to an estimated molecular weight of 320,000 g/mol.

### EXAMPLE 7-8

### Homopolymerization in Hydrofluoroether/Carbon Dioxide

Homopolymerization of TFE is run and worked up in a manner similar to that in example 6 using a HFE-449mccc (CH₃OC₄F₉)/carbon dioxide and a HFE-227me (CF₃OCFHCF₃)/carbon dioxide medium respectively.

### EXAMPLE 9-14

### Copolymerization in Acetic Acid/Carbon Dioxide

Copolymerizations of TFE/HFP, TFE/PPVE, TFE/PMVE, TFE/Ethylene, VDF/PEVE-Br and VDF/TFE/PEVE-Br are run and worked up in an acetic acid/carbon dioxide medium in a manner similar to that in example 1.

### EXAMPLE 15

### VDF Homopolymerization in Acetic Acid/Carbon Dioxide

Homopolymerization of vinylidene fluoride is run and worked up in an acetic acid/carbon dioxide medium in a manner similar to that in example 1.

### EXAMPLE 16

### TFE Homopolymerization in Heterogeneous Medium

A 25 ml high pressure reactor cell is purged with carbon dioxide to remove air. An aqueous solution (12 ml) of methyl cellulose (0.0036 g) and potassium persulfate (0.0131 g) is first purged with Argon to remove oxygen and then injected into the reactor under positive pressure of Argon, and the reactor is resealed. A mixture of 50/50 by weight tetrafluoroethylene and carbon dioxide (5.23 ml, 4.87 g) is pushed into the reactor cell through high pressure syringe pump and then condensed by cooling to below −40° C. through a dry ice/acetone bath. The reactor is then slowly heated to 70° C. When the temperature is well above 0° C., a magnetic stirrer is turned on to maintain a maximum speed. The pressure inside the reactor is approximately 960 psi initially, slowly drop during the polymerization until it reaches 870 psi after reaction is terminated. The reaction was held for 20 hours before being cooled down to room temperature. Carbon dioxide, excess tetrafluoroethylene and whatever volatile are slowly vented until the pressure reaches equilibrium with air. The reactor is opened, the product, which is a milky emulsion with apparent coagulation, is collected. It is then coagulated with salt, filtered, and then washed with water multiple times. The polymer is then dried in a vacuum oven at elevated temperature and a white powder of approximately 0.66 g is obtained (27.3% yield). Thermogravimetric analysis gives a 5% loss at 492° C. Differential scanning calorimetry shows a melting from approximately 300 to 340° C. and centered at 327.7° with a 10°/min. heating rate. Integration of the melting peak gives a heat of crystallization of 24.7 J/g corresponding to an estimated molecular weight of 2,200,000 g/mol.

### EXAMPLE 17

### TFE Homopolymerization in Heterogeneous Medium

The same recipe and conditions are used as example 16 except that extra carbon dioxide is added to increase the initial pressure in the reactor to 2500 psi after the polymerization temperature is brought up to 70°. The reaction is then run and worked in a manner similar to that in example 16.

### EXAMPLE 18-22

### Copolymerization of Fluoromonomers in Heterogeneous Medium

Copolymerizations of TFE/HFP, TFE/PPVE, TFE/Ethylene, VDF/PEVE-Br and VDF/TFE/PEVE-Br are run in a similar medium as in example 17 and worked up in a similar manner to that in example a 16 respectively.

The foregoing is illustrative of the present invention, and is not to be construed as limiting thereof. The invention is defined by the following claims, with equivalents of the claims to be included therein.

1. A process of making a fluoropolymer from at least one fluoromonomer, comprising;
(a) polymerizing said at least one fluoromonomer in a polymerization medium to produce said fluoropolymer; wherein said medium is a heterogeneous medium comprising carbon dioxide and an aqueous phase wherein said polymerization medium is essentially free of fluorosurfactants, and wherein said polymerizing step is carried out at a pressure not greater than 2400 psi; and then:
(b) separating said fluoropolymer from said polymerization medium.

2-3. (canceled)

4. The process of claim 1, wherein said at least one fluoropolymer is selected from the group consisting of fluoroolefins, fluorinated vinyl ethers, fluoroacrylates, fluorostyrenes, fluoroalkylene oxide oligomers, and combinations thereof.

5. The process of claim 1, wherein said polymerizing step is a free radical polymerizing step.

6. The process of claim 1, wherein said polymerization medium further comprises an organic acid.

7. The process of claim 1, wherein said polymerization medium consists essentially of carbon dioxide, water, organic acid, free radical initiator, at least one fluoromonomer, said at least one polymer when present, optionally hydrocarbon surfactant, optionally dispersant, and optionally stabilizer.

8. The process of claim 1, wherein said polymerization medium further comprises a ketone.

9. The process of claim 1, wherein said polymerization medium further comprises an ether.

10. The process of claim 1, wherein said polymerization medium further comprises an organic chloride.

11. The process of claim 1, wherein said polymerization medium further comprises an ester.

12. The process of claim 1, wherein said polymerization medium further comprises a solvent selected from the group consisting of acetonitrile, DMSO, and cyclohexanone.

13. The process of claim 1, wherein said polymerization medium further comprises a fluorocarbon.

14. A fluoropolymer produced by the process of claim 1, optionally wherein said fluoropolymer is essentially free of fluorosurfactants.

15. A heterogenous polymerization medium, comprising at least one fluoromonomer or a fluoropolymer, wherein said polymerization medium is essentially free of fluorosurfactants, and wherein said polymerization medium is at a pressure not greater than 2400 psi.

16-17. (canceled)

18. The polymerization medium of claim 15, wherein said at least one fluoropolymer is selected from the group consisting of fluoroolefins, fluorinated vinyl ethers, fluoroacrylates, fluorostyrenes, fluoroalkylene oxide oligomers, and combinations thereof.

19. The polymerization medium of claim 15, said medium further comprising a free radical polymerization initiator.

20. The polymerization medium of claim 15, said medium further comprising an organic acid.

21. The polymerization medium of claim 15, wherein said polymerization medium consists essentially of carbon dioxide, water, organic acid, free radical initiator, said at least one fluoromonomer when present, said at least one polymer when present, optionally hydrocarbon surfactant, optionally dispersant, and optionally stabilizer.

22. The polymerization medium of claim 15, said medium further comprising a ketone.

23. The polymerization medium of claim 15, said medium further comprising an ether.

24. The polymerization medium of claim 15, said medium further comprising an organic chloride

25. The polymerization medium of claim 15, said medium further comprising an ester.

26. The polymerization medium of claim 15, said medium further comprising a solvent selected from the group consisting of acetonitrile, DMSO, and cyclohexanone.

27. The polymerization medium of claim 15, said medium further comprising a fluorocarbon.
